(19) United States
(12) Patent Application Publication
(10) Pub. No.: US 2005/0109793 A1
(43) Pub. Date: May 26, 2005

(54) Low product indicator for use with a tablet chlorinator

(76) Inventor: John E. Thomas, River Falls, WI (US)

Correspondence Address: IPLM GROUP, P.A., POST OFFICE BOX 18455, MINNEAPOLIS, MN, 55418, US

(21) Appl. No.: 10/721,540

(22) Filed: Nov. 25, 2003

(51) Int. Cl. B67D 5/00; G07F 11/00

(52) U.S. Cl. 222/6

(57) ABSTRACT

A low product indicator (20) includes a cap (21) having an aperture (22) and a rod (23) extending through the aperture (22) for contacting a product (17). A biasing member (25) is operatively connected to the rod (23) thereby biasing the rod (23) against the product (17) allowing the rod (23) to move through the cap (21) as the product (17) is dispensed. Visual indication of a level of the product (17) is evident as the rod (23) moves through the cap (21).

### BACKGROUND OF THE INVENTION

1. Field of the Invention

The present invention relates to a low product indicator for use with a tablet chlorinator.

2. Description of the Prior Art

Chlorine tablets are commonly used in swimming pools and spas to maintain a sanitary condition of the water. The chlorine is typically dispensed by placing the chlorine tablets within a tablet chlorinator, which allows water to enter the tablet chlorinator, dissolve a portion of the chlorine tablets, and then release the dissolved chlorine into the swimming pool or spa. Currently, to observe the level of product in a tablet chlorinator, the pump must be turned off and the cover of the tablet chlorinator must be removed to visually inspect the amount of product contained within the tablet chlorinator. If the product is not checked regularly, the product may run out completely and a chemical imbalance will occur in the pool or spa. Therefore, it is important to regularly check the tablet chlorinator to ensure that adequate product is contained within the tablet chlorinator for health reasons.

Another problem associated with using chlorine tablets is that they tend to swell and become stuck to the sides of the tablet chlorinator causing the device to malfunction. Therefore, it is important to ensure that the chlorine tablets do not catch on the sides of the dispensing device to provide a sanitary condition of the water.

### SUMMARY OF THE INVENTION

In a preferred embodiment low product indicator, a cap includes an aperture, and a rod extends through the aperture for contacting a product. A biasing member is operatively connected to the rod thereby biasing the rod against the product allowing the rod to move through the cap as the product is dispensed. Visual indication of a level of the product is evident as the rod moves through the cap.

In a preferred embodiment low product indicator for use with a dispenser, a cap includes an aperture, and the cap is configured and arranged to be operatively connected to a dispenser. A rod extends through the aperture for contacting a product, and a biasing member is operatively connected to the rod thereby biasing the rod against the product allowing the rod to move through the cap as the product is dispensed. Visual indication of a level of the product is evident as the rod moves through the cap.

In a preferred embodiment low product indicator for use with a dispenser for dispensing a product, the dispenser includes an opening and a chamber containing the product. A cap is configured and arranged to cover the opening of the dispenser, and the cap includes an aperture. A fixed member is operatively connected to the cap. A rod extends through the aperture and the opening into the chamber and contacts the product within the chamber. A biasing member is operatively connected to the rod thereby biasing the rod against the fixed member to provide positive pressure against the product and to indicate when the product is low within the dispenser.

In a preferred embodiment method of determining a level of a product within a dispenser, the dispenser includes an opening proximate the product and a support member for holding the product within the dispenser. A product is supplied to a dispenser including an opening proximate the product and a support member for holding the product within the dispenser. A product indicator is placed over the opening of the dispenser. The product indicator includes a cap with an aperture, and a rod extends through the aperture into the dispenser and contacts the product. A biasing member is operatively connected to the rod, wherein the rod is biased to contact the product. The product is urged down to the support member with the rod. The product is dissolved by applying liquid proximate the support member thereby causing the rod to move through the cap as the product is dissolved by providing positive pressure against the product and indicating a level of the product within the dispenser.

In a preferred embodiment dispensing device with a low product indicator for dispensing chlorine tablets, a dispenser includes a chamber, a refill end having an opening providing access to said chamber, and a dispensing end. Chlorine tablets are added to the opening of the refill end into the chamber and are dispensed through the dispensing end. A cap covers the opening and includes an aperture. A rod extends through the aperture and the opening into the chamber and has contact with the chlorine tablets. A biasing member is operatively connected to the rod thereby biasing the rod, wherein the rod provides positive pressure against the chlorine tablets to push the chlorine tablets down proximate the dispensing end. An indicator is operatively connected to the rod, wherein the indicator provides visual indication of an amount of the chlorine tablets within the chamber as the rod pushes the chlorine tablets down proximate the dispensing end.

In a preferred embodiment dispensing device with a low product indicator, a dispenser includes a chamber, a refill end having an opening providing access to the chamber, and a dispensing end. A product is contained within the chamber and is dispensed through the dispensing end. A cap covers the opening and includes a first aperture. A fixed member is operatively connected to the cap, and the fixed member includes a top with a second aperture displaced from the cap. The fixed member creates a cavity between the top and the cap. A rod has a flange, and the rod extends from within the cavity, through the first aperture and the opening, and into the chamber. The rod contacts the product, and the flange is within the cavity. A spring is contained within the cavity of the fixed member, and the spring provides force between the top of the fixed member and the flange of the rod thereby pushing the rod into the chamber of the dispenser. An indicator is operatively connected to the rod, wherein the indicator extends through the second aperture to provide visual indication of an amount of the product within the chamber as the rod pushes the product down proximate the dispensing end.

### BRIEF DESCRIPTION OF THE DRAWINGS

FIG. 1A is a cross sectional view of a low product indicator and dispenser constructed according to the principles of the present invention;

FIG. 1B is a partial cross sectional view of an O-ring assembly of the low product indicator and dispenser shown in FIG. 1A;

FIG. 2 is an exploded perspective view of the low product indicator shown in FIG. 1A;

FIG. 3 is a schematic view showing a tablet chlorinator connected to a pool system; and

FIG. 4 is a tablet chlorinator for use with the low product level indicator and dispenser shown in FIG. 1A.

### DETAILED DESCRIPTION OF THE PREFERRED EMBODIMENT

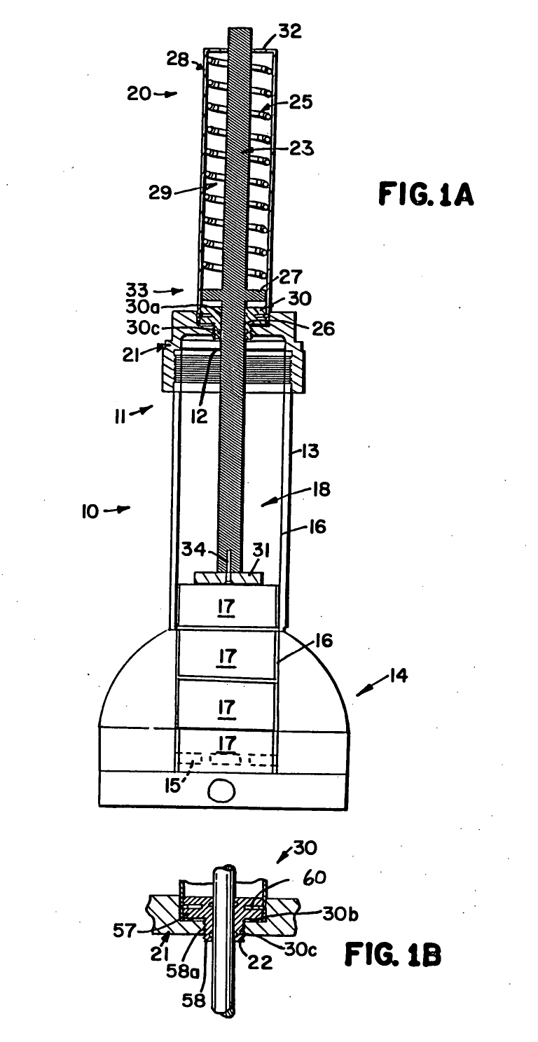

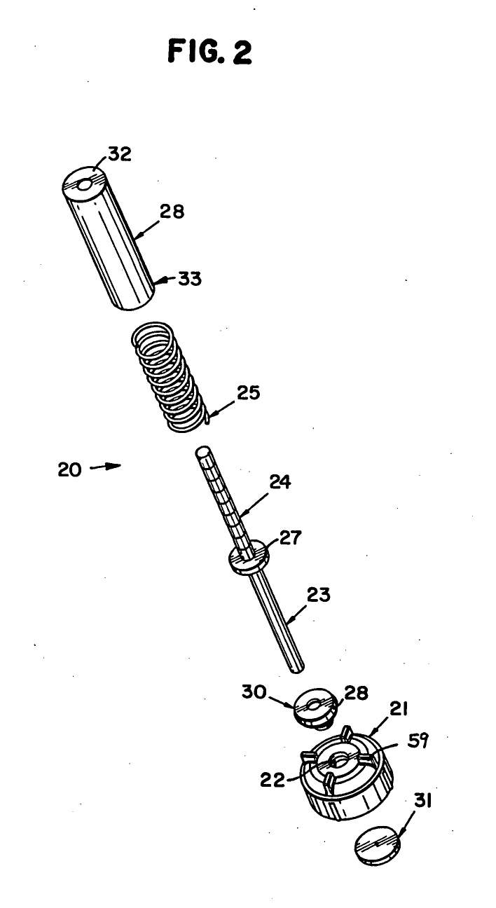

A preferred embodiment low product level indicator constructed according to the principles of the present invention is designated by the numeral 20 in FIGS. 1A and 2.

In the preferred embodiment, the low product level indicator 20 is shown and described for use with a dispenser or tablet chlorinator 10 for dispensing chlorine tablets 17. Although chlorine tablets 17 dispensed within the tablet chlorinator 10 is shown and described, it is recognized that the present invention may be used with other products that are dispensed in similar dispensers well known in the art.

The preferred embodiment tablet chlorinator 10 includes a chamber 13 having a refill end 11 and a dispensing end 14. The chamber 13 is generally cylindrical in shape to accommodate the size and shape of the product or chlorine tablets 17. However, the chamber 13 may be any size and shape to accommodate various size and shape products. An opening 12 in the refill end 11 allows access to a cavity 18, in which the chlorine tablets 17 are placed. The cavity 18 proximate the refill end 11 preferably has a diameter of approximately 3⅞ inches and a length of approximately 17¼ inches. A support member or product sleeve 16 within the cavity 18 supports the product 17 proximate the dispensing end 14. The support member 16 is a cylindrical tube configured and arranged to fit within the cavity 18 and house the product 17. The support member 16 preferably has a length of 16¼ inches and a diameter of 3⅝ inches. Apertures 15 proximate the bottom of the support member 16 allow water to flow into and out of the support member 16 to dissolve and dispense a portion of the product 17. The support member 16 is a sleeve member connected to the top of the opening 12 and is suspended therefrom into the cavity 18. Therefore, a liquid is applied proximate the support member 16 to dissolve the product 17. It is recognized that other similar dispensers known in the art may be used, and the dimensions may vary to accommodate various sizes and shapes of product.

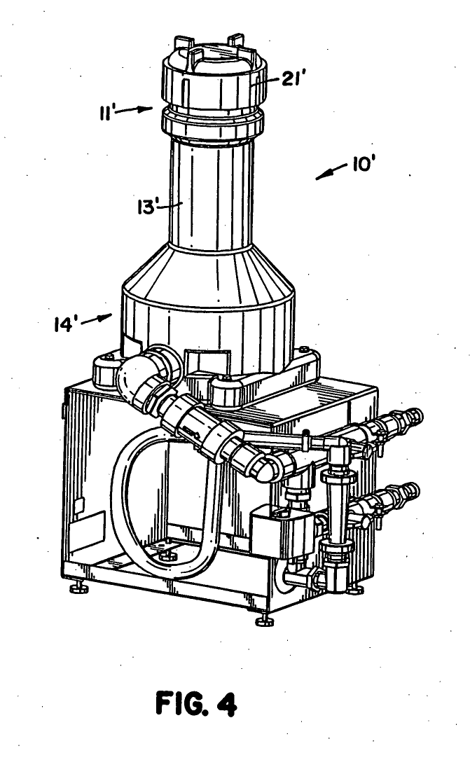

In the prior art, a cover 21′ typically protects an opening at the top of a prior art dispenser 10′, but the cover 21′ is replaced with cap 21 when the low product indicator 20 is used, as shown in FIG. 1A. The prior art dispenser 10′ shown in FIG. 4 is well known in the art and includes a chamber 13′ having a refill end 11′ and a dispensing end 14′. An example of a suitable dispenser is the AQUA BALANCE® N-200 CHLORNINATOR manufactured by Ecolab Inc.

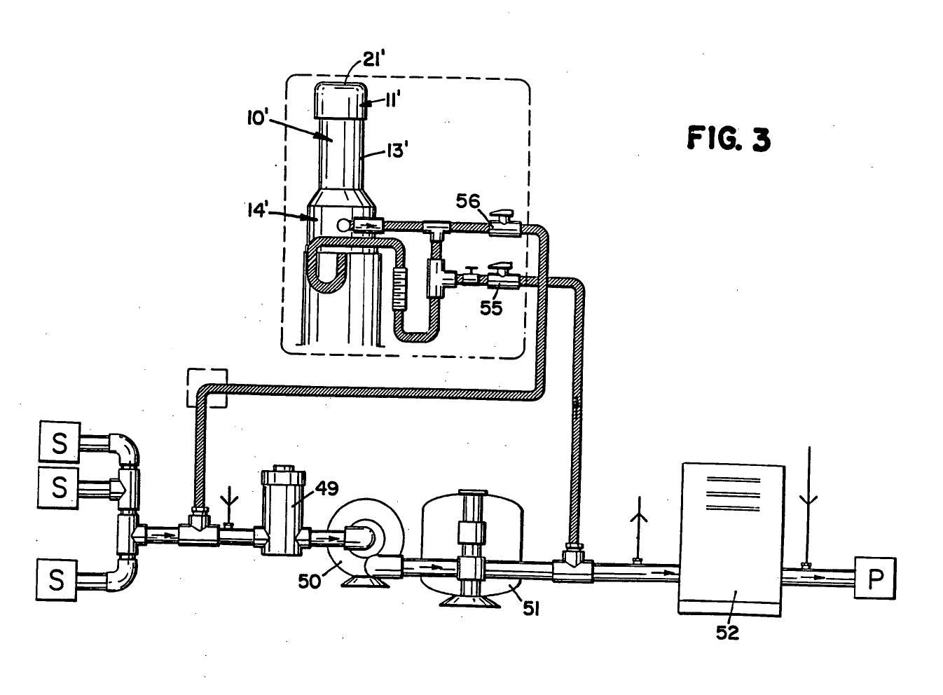

Chlorine is typically added to the re-circulation water system of a pool as shown in the schematic in FIG. 3. An inlet valve 55 of the chlorine dispenser 10′ is typically connected to the discharge side of a pump 50 after a filter 51 but before injection of muriatic acid. An outlet valve 56 of the chlorine dispenser 10′ is typically connected to the suction side of the pump 50 after the section lines S but before the strainer 49. In other words, water is taken from the discharge of the main re-circulation pump, the water flows past the chlorine tablets, and the chlorinated water returns back to the suction side of the main re-circulation pump. The chlorinated water then flows through the heater 52 and is returned to the pool P. The water supply is from connections on the pool return and suction lines. To refill the chlorinator 10′, the chlorinator 10′ must be shut down, the cover 21′ must be removed, product must be added to the chamber 13′, the cover 21′ must be replaced, and the chlorinator 10′ must be put back in line. However, it is difficult to determine the amount of product remaining in the chamber 13′. Therefore, the steps to refill the chlorinator 10′ must also be performed to determine whether additional product is required. This can be a hassle.

The preferred embodiment low product indicator 20 is shown in FIGS. 1A and 2. A cap 21 having an aperture 22 is configured and arranged to cover the top of the opening 12 of the dispenser 10 and is approximately 4⅞ inches in diameter. The cap 21 and the refill end 11 of the dispenser 10 each include threads that mate with one another to secure the cap 21 to the refill end 11. An O-ring seals the connection between the cap 21 and the dispenser 10. The aperture 22 is threaded and is also configured and arranged to accommodate a rod or plunger 23, which is an elongated shaft approximately 24.50 inches long and approximately 1.00 inches in diameter.

The rod 23 includes product level indicator lines 24 proximate the top of the rod 23 and extending upward from a flange 27. Proximate the middle of the rod 23 is the flange 27, which is positioned above the cap 21 and is approximately 2.75 inches in diameter. The flange 27 serves as a stopper for the rod 23 proximate the cap 21 to ensure that the rod 23 does not extend too far into the chamber 13 and it provides a surface upon which a biasing member 25 can exert pressure to push the rod 23 into the chamber 13. The biasing member 25 of the preferred embodiment is a spring, but a weighted handle of rod 23, rubber bands, or other biasing members well known in the art could also be used. The flange 27 and the biasing member 25 are contained within a cavity 29 of a housing or fixed member 28.

The housing or fixed member 28 also includes a top 32 and a lower portion 33, the lower portion 33 including an O-ring or seal assembly 30. The housing or fixed member 28 is operatively connected to the cap 21 but is displaced away from the cap 21 so that the biasing member 25 is between the top 32 and the cap 21. The top 32 provides a surface upon which the biasing member 25 also exerts pressure to push the rod 23 into the chamber 13. Therefore, the biasing member 25 is contained within the cavity 18 and exerts pressure upon the top 32 (which does not move) of the housing 28 and the flange 27 (which does move) of the rod 23 to push the rod 23 into the cavity 18.

The O-ring assembly 30 is proximate the top of the cap 21 where the housing 28 is connected to prevent water and/or dissolved product from exiting the refill end 11 of the dispenser and entering the low product indicator 20. The O-ring assembly 30 is preferably operatively connected to the lower portion 33 of the housing 28 by screws 60, and it is recognized that other fastening means well known in the art may be used. The O-ring assembly 30 includes a base portion 57, which is configured and arranged to fit within the lower portion 33, and the screws 60 fasten the lower portion 33 to the base portion 57. A neck portion 58 extends from the base portion 57 and includes threads 58a. An aperture 26 configured and arranged to accommodate the rod 23 extends through the O-ring assembly 30 so that the rod 23 may extend from the cavity 29, through the O-ring assembly 30, and into the cavity 18. An O-ring 30a within a groove in the base portion 57 proximate the aperture 26 and the center of the base portion 57 seals the base portion 57 around the rod 23, even as the rod 23 moves up and/or down within the aperture 26. An O-ring 30b within a groove in the bottom of the base portion 57 proximate the top of the threaded portion 58a of the neck portion 58 seals the connection between the housing 28 and the cap 21. An O-ring 30c within a groove in the neck portion 58 proximate the aperture 26 and the center of the neck portion 58 seals the neck portion 58 around the rod 23, even as the rod 23 moves up and/or down within the aperture 26.

Threads within the aperture 22 of the cap 21 are configured and arranged to mate with threads 58a in the neck portion 58 of the O-ring assembly 30, and the mating threads operatively connect the cap 21 and the housing 28. The cap 21 and the housing 28 could also be interconnected in other ways well known in the art. Four ledges 59 approximately 90 degrees apart extend radially from the aperture 22 in the center of the cap 21 to hold the housing 28 in place. The rod extends through the housing 28, through the cap 21, and into the cavity 18 where it contacts the product 17 with a rod end 31. The rod end 31 is a relatively flat disk shaped member secured to the bottom end of rod 23 with a screw 34 to ensure that even pressure is exerted upon the product 17 by the rod 23. The rod end 31 is approximately 3.00 inches in diameter, 0.50 inches thick, and 12.00 inches from the flange 27.

In addition, a signal mechanism could be added to the present invention to provide audio or visual indication of when the product level is low. An alarm could sound or a light could be illuminated. As the plunger 23 pushes the product 17, a switch could be activated to trigger an audio or visual alarm. Various types of switches could be used. For example, the alarm could be activated by a spring-loaded toggle switch flipped by the plunger, a reed switch, a micro-switch, or other alarm means well known in the art. The alarm means would eliminate the need to actually observe the low product indicator 20 and the position of the plunger 23.

In operation, the dispenser 10 is operatively connected to the re-circulation water system of the pool, as in the prior art dispenser 10′ and as shown in FIG. 3. The low product indicator 20 is incorporated into the cap 21 covering the opening 12 of the tablet chlorinator 10. Therefore, the existing cover of the dispenser 10 is replaced with the cap 21 of the low product indicator 20. The biasing member 25 exerts a constant pressure on the rod 23 thereby pushing the rod 23 into the cavity 18 of the dispenser 10. When the dispenser 10 is full of product 17, the product 17 prevents the rod 23 from extending fully into the cavity 18. In other words, the more product 17 contained within the cavity 18, the more compressed the biasing member 25 is and the less the rod 23 extends into the cavity 18. However, as the product 17 is dispensed and the product level decreases within the cavity 18, the further the rod 23 will extend into the cavity 18. The spring loaded rod 23 provides positive pressure against the chlorine tablets 17 within the dispenser 10 to push the chlorine tablets 17 down to the dispensing end 14 where the product 17 is dispensed into the water of the pool or spa. The rod 23 having indicator lines 24 moves into the housing 28 as the product tablets 17 are dispensed thereby providing visual indication of the product level. In other words, the more product, the more rod 23 and a greater number of indicator lines 24 extend from the top 32 of the housing 28. Conversely, the less product, the fewer rod 23 and a fewer number of indicator lines 24 extend from the top 32 of the housing 28. The spring-loaded force on the chlorine tablets 17 also helps the tablets 17 move through the dispenser 10 and helps prevent the tablets 17 from catching on the walls of the chamber 13.

The top of the rod 23 could include a sticker or other notification that product 17 should be added to the dispenser 10. Not only could the product level indicator lines 24 provide visual indication of the product level, but a light or an audible indication could also be added to alert when the product level is low. Again, for example, a reed switch (not shown) could be placed on the rod 23. When the rod 23 is pushed into the cavity 18 far enough to where product 17 should be added, magnets (not shown) placed within the cavity 18 would create a magnetic field around the reed switch. The magnetic field causes the reed switch contacts to close, allowing electricity to flow and activate an alert system (not shown) thereby indicating to the operator the need to add more product 17.

The above specification, examples and data provide a complete description of the manufacture and use of the composition of the invention. Since many embodiments of the invention can be made without departing from the spirit and scope of the invention, the invention resides in the claims hereinafter appended.

1. A low product indicator, comprising:
a) a cap including an aperture;
b) a rod extending through said aperture for contacting a product; and
c) a biasing member operatively connected to said rod thereby biasing said rod against the product allowing said rod to move through said cap as the product is dispensed, wherein visual indication of a level of the product is evident as said rod moves through said cap.

2. The low product indicator of claim 1, further comprising a fixed member operatively connected to said cap, said biasing member exerting force against said fixed member thereby pushing said rod through said cap.

3. The low product indicator of claim 2, wherein said biasing member is a spring.

4. The low product indicator of claim 1, further comprising a signal mechanism, said signal mechanism being operatively connected to said rod and providing indication when the level of the product is low.

5. A low product indicator for use with a dispenser, comprising:
a) a cap including an aperture, the cap configured and arranged to be operatively connected to a dispenser;
b) a rod extending through said aperture for contacting a product; and
c) a biasing member operatively connected to said rod thereby biasing said rod against the product allowing said rod to move through said cap as the product is dispensed, wherein visual indication of a level of the product is evident as said rod moves through said cap.

6. The low product indicator of claim 5, further comprising a fixed member operatively connected to said cap, said biasing member exerting force against said fixed member thereby pushing said rod through said cap.

7. The low product indicator of claim 6, wherein said biasing member is a spring.

8. The low product indicator of claim 5, further comprising a signal mechanism, said signal mechanism being operatively connected to said rod and providing indication when the level of the product is low.

9. A low product indicator for use with a dispenser for dispensing a product, the dispenser including an opening and a chamber containing the product, comprising:
a) a cap configured and arranged to cover an opening of a dispenser, said cap including an aperture;
b) a fixed member operatively connected to said cap;
c) a rod extending through said aperture and the opening into the chamber and contacting the product within the chamber; and
d) a biasing member operatively connected to said rod thereby biasing said rod against said fixed member to provide positive pressure against the product and to indicate when the product is low within the dispenser.

10. The low product indicator of claim 9, wherein said biasing member is a spring.

11. The low product indicator of claim 9, further comprising a signal mechanism, said signal mechanism being operatively connected to said rod and providing indication when the level of the product is low.

12. A method of determining a level of a product within a dispenser, the dispenser including an opening proximate the product and a support member for holding the product within the dispenser, comprising:
a) supplying a product to a dispenser, the dispenser including an opening proximate the product and a support member for holding the product within the dispenser;
b) placing a product indicator over the opening of the dispenser, said product indicator including a cap with an aperture, a rod extending through said aperture into the dispenser and contacting the product, and a biasing member operatively connected to said rod, wherein said rod is biased to contact the product;
c) urging the product down to the support member with said rod; and
d) dissolving the product by applying liquid proximate the support member thereby causing said rod to move through said cap as the product is dissolved by providing positive pressure against the product and indicating a level of the product within the dispenser.

13. A dispensing device with a low product indicator for dispensing chlorine tablets, comprising:
a) a dispenser including a chamber, a refill end having an opening providing access to said chamber, and a dispensing end;
b) chlorine tablets within said chamber, the chlorine tablets being added to said opening of said refill end into said chamber and being dispensed through said dispensing end;
c) a cap covering said opening and including an aperture;
d) a rod extending through said aperture and said opening into said chamber and having contact with the chlorine tablets;
e) a biasing member operatively connected to said rod thereby biasing said rod, wherein said rod provides positive pressure against the chlorine tablets to push the chlorine tablets down proximate said dispensing end; and
f) an indicator operatively connected to said rod, wherein said indicator provides visual indication of an amount of the chlorine tablets within said chamber as said rod pushes the chlorine tablets down proximate said dispensing end.

14. The dispensing device with a low product indicator of claim 13, wherein said biasing member is a spring.

15. The dispensing device with a low product indicator of claim 13, further comprising a signal mechanism, said signal mechanism being operatively connected to said rod and providing indication when the level of the product is low.

16. A dispensing device with a low product indicator, comprising:
a) a dispenser including a chamber, a refill end having an opening providing access to said chamber, and a dispensing end;
b) a product contained within said chamber and dispensed through said dispensing end;
c) a cap covering said opening and including a first aperture;
d) a fixed member operatively connected to said cap, said fixed member including a top with a second aperture displaced from said cap, said fixed member creating a cavity between said top and said cap;
e) a rod having a flange, said rod extending from within said cavity, through said first aperture and said opening, and into said chamber, said rod having contact with the product, said flange being within said cavity;
f) a spring contained within said cavity of said fixed member, said spring providing force between said top of said fixed member and said flange of said rod thereby pushing said rod into said chamber of said dispenser; and
g) an indicator operatively connected to said rod, wherein said indicator extends through said second aperture to provide visual indication of an amount of the product within said chamber as said rod pushes the product down proximate said dispensing end.

17. The dispensing device of claim 16, wherein the product is chlorine tablets.

18. The dispensing device of claim 16, further comprising a signal mechanism, said signal mechanism being operatively connected to said rod and providing indication when the level of the product is low.
